(19) United States
(12) Patent Application Publication
(10) Pub. No.: US 2026/0249652 A1
(43) Pub. Date: Aug. 27, 2026

(54) HEAVY LOAD TIRE

(71) Applicant: Toyo Tire Corporation, Hyogo (JP)

(72) Inventor: Ayaki TANAKA, Hyogo (JP)

(21) Appl. No.: 19/546,733

(22) Filed: Feb. 23, 2026

(30) Foreign Application Priority Data
Feb. 25, 2025 (JP) 2025-028286

(51) Int. Cl. B60C 11/03; B60C 11/12

(52) U.S. Cl. CPC B60C 11/0306; B60C 11/12; B60C 2011/0353; B60C 2011/0355; B60C 2200/06

(57) ABSTRACT

A tread of a heavy load tire includes a center land part and a shoulder land part. A first circumferential groove is formed between the center land part and the shoulder land part, and a second circumferential groove is formed at approximately the center, in the tire width direction, of the center land part. The center land part is divided into center blocks by the second circumferential groove and by first widthwise grooves arranged sequentially in the tire circumferential direction. The center blocks have formed therein: a bent sipe, which extends in the tire circumferential direction, has both ends opening into the first widthwise grooves, and includes two bends; and a short sipe, which extends in the tire circumferential direction, has one end opening into a first widthwise groove, and has the other end terminating within a center block.

### CROSS REFERENCE TO RELATED APPLICATION

This application claims priority to Japanese Patent Application No. 2025-028286 filed on Feb. 25, 2025, which is incorporated herein by reference in its entirety including the specification, claims, drawings, and abstract.

### TECHNICAL FIELD

The present disclosure relates to a heavy load tire.

### BACKGROUND

In heavy load tires used for large-sized vehicles, a center land part where the ground contact pressure is high wears easily, and uneven wear tends to occur in a shoulder land part due to a large lateral force being applied thereto at the time of turning. Such tendency is notable particularly when the heavy load tires are used for an electric vehicle (EV), which has a large vehicle body weight and accordingly applies a large torque to the tires. Patent Literature 1 discloses a tire wherein, in order to simultaneously achieve sufficient wear resistance and wet performance, a center land part is composed of center blocks, and each center block includes a center microgroove which has both of its ends connected to center lug grooves extending in the tire width direction, and which has a predetermined shape including two or more bends at midway points.

### CITATION LIST

### Patent Literature

Patent Literature 1: JP 2024-110220 A

### SUMMARY

Generally, when stiffness of a center land part is increased by a method such as decreasing the number of grooves or sipes or reducing their depths, wear resistance improves, but traction performance deteriorates. In the technique of Patent Literature 1, there is still room for improvement in addressing such suppression of traction performance.

An object of the present disclosure is to provide a heavy load tire which simultaneously achieves sufficient stiffness of the center land part and sufficient traction performance, and which exhibits excellent suppression of uneven wear.

A heavy load tire according to an aspect of the present disclosure has a tread including a center land part and a shoulder land part. A first circumferential groove extending in the tire circumferential direction is formed between the center land part and the shoulder land part. A second circumferential groove extending in the tire circumferential direction is formed at approximately the center, in the tire width direction, of the center land part. The center land part is divided into center blocks by the second circumferential groove and by first widthwise grooves arranged sequentially in the tire circumferential direction. The center blocks have formed therein: a bent sipe, which extends in the tire circumferential direction, has both ends opening into the first widthwise grooves, and includes two bends; and a short sipe, which extends in the tire circumferential direction, has one end opening into a first widthwise groove, and has the other end terminating within a center block.

In the above-described heavy load tire, the depth of the first widthwise grooves may be greater than or equal to 10% and less than or equal to 30% of the depth of the first circumferential groove, and a first groove bottom sipe may be formed at the groove bottom of the first widthwise grooves.

In the above-described heavy load tire, open ends of the bent sipe and an open end of the short sipe may be located within a range of greater than or equal to 15% and less than or equal to 20% of the width of the center block from the center, in the tire width direction, of the center block.

In the above-described heavy load tire, in the bent sipe, the depth at open ends and the bends may be greater than or equal to 5% and less than or equal to 30% of the depth of the first circumferential groove, and the depth at portions other than the open ends and the bends may be greater than or equal to 50% and less than or equal to 70% of the depth of the first circumferential groove.

In the above-described heavy load tire, in the groove bottom sipe, the depth at a central portion may be greater than or equal to 20% and less than or equal to 40% of the depth of the first circumferential groove, and the depth at portions other than the central portion may be greater than or equal to 80% and less than or equal to 100% of the depth of the first circumferential groove.

In the above-described heavy load tire, the width of the second circumferential groove may be less than the width of the first circumferential groove.

In the above-described heavy load tire, the width of the first circumferential groove may be greater than or equal to 2.5% and less than or equal to 7% of the width between ground contact edges of the tread, and the width of the second circumferential groove may be greater than or equal to 2% and less than or equal to 5% of the width between the ground contact edges of the tread. Further, the distance between the first circumferential groove and the second circumferential groove may be greater than or equal to 20% and less than or equal to 28% of the width between the ground contact edges of the tread.

In the above-described heavy load tire, second widthwise grooves may be connected to lug grooves formed in a sidewall, and the lug grooves may have a depth in the tire radial direction that is greater than that of the first circumferential groove.

In the above-described heavy load tire, a side sipe may be formed between the lug grooves. In the tire radial direction, an end of the side sipe may be in contact with a ground contact edge or may extend beyond the ground contact edge to the tread, and the other end of the side sipe may extend to a position deeper than the first circumferential groove.

In the above-described heavy load tire, a side protector protruding outward of the tire from a profile face may be formed on the sidewall, and a surface of the side protector may be planar.

A heavy load tire according to the present disclosure simultaneously achieves sufficient stiffness of the center land part and sufficient traction performance, and exhibits excellent suppression of uneven wear.

### BRIEF DESCRIPTION OF DRAWINGS

Embodiment(s) of the present disclosure will be described based on the following figures, wherein:

FIG. 1 is a perspective view showing a part of a heavy load tire according to an example embodiment;

FIG. 2 is an enlarged view of a part of the tread of the heavy load tire according to an example embodiment;

FIG. 3 is a cross-sectional view taken along line A-A in FIG. 2;

FIG. 4 is a cross-sectional view taken along line B-B in FIG. 2;

FIG. 5 is a cross-sectional view taken along line C-C in FIG. 2;

FIG. 6 is a cross-sectional view taken along line D-D in FIG. 2;

FIG. 7 is an enlarged view of a center block of the heavy load tire according to an example embodiment;

FIG. 8 is a cross-sectional view taken along line E-E in FIG. 7;

FIG. 9 is a diagram showing changes in the tread caused by wear in the heavy load tire according to an example embodiment; and

FIG. 10 is an enlarged view of a part of a sidewall of the heavy load tire according to an example embodiment.

### DESCRIPTION OF EMBODIMENTS

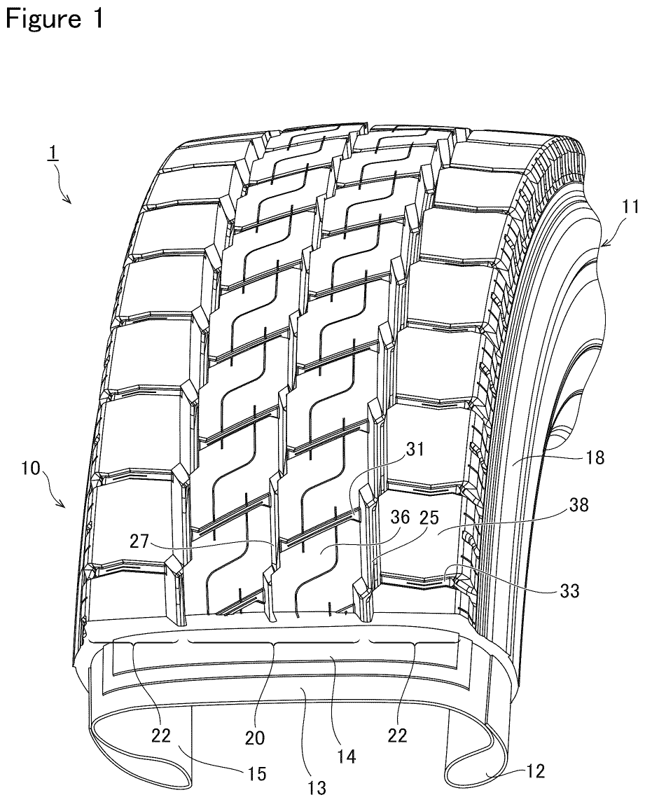

Example embodiments of a heavy load tire according to the present disclosure will now be described in detail by reference to the drawings. The embodiments described below are merely examples, and the present disclosure is not limited to the embodiments below. Further, selective combinations of constituent elements of the embodiments and variants described below are within the scope of the present disclosure. FIGS. 1 to 8 each show aspects of a tread 10 in an unused state. In the following description, the “depth” denotes the maximum depth.

FIG. 1 is a perspective view showing a part of a heavy load tire 1 according to an example embodiment, and also illustrates the internal structure of the tire. As shown in FIG. 1, the heavy load tire 1 has a tread 10 which is a part that comes into contact with the road surface, a pair of sidewalls 11 extending radially inward of the tire from the tread 10, and a pair of beads 12 which are placed in contact with the rim of a wheel. The tread 10, the sidewalls 11, and the beads 12 are formed in an annular shape along the tire circumferential direction. The sidewalls 11 and the beads 12 constitute left and right side faces of the heavy load tire 1.

The heavy load tire 1 comprises a carcass 13, a belt 14, and an inner liner rubber 15. The carcass 13 is a layer of cords covered with rubber, and forms the skeleton of the heavy load tire 1 configured to withstand load, shock, air pressure, and the like. On the inner side of the tread 10 in the tire radial direction, the carcass 13 is arranged spanning across the pair of beads 12, and is folded over at the beads 12 from the inner side to the outer side in the tire radial direction. The belt 14 is a reinforcement band arranged on the outer side of the carcass 13 in the tire radial direction, and tightly constricts the carcass 13 to increase stiffness of the heavy load tire 1. The belt 14 is composed of, for example, steel cords covered with rubber. The inner liner rubber 15 is a rubber layer provided on the inner side of the carcass 13 in the tire radial direction, and maintains air pressure in the heavy load tire 1.

The heavy load tire 1 comprises bead cores and bead fillers. A bead core and a bead filler are provided in each of the beads 12 on the left and right sides. The bead core is a ring-shaped member composed of a steel wire bundle covered with rubber. The bead filler is composed of hard rubber, and has the function of increasing stiffness of the bead 12.

On a sidewall 11, a side protector 18 is formed, which protrudes outward of the tire from the profile face. Here, the “profile face” denotes the contour of the outer surface of the sidewall body portion, excluding any projections such as the side protector 18. The side protector 18 is formed in an annular shape along the tire circumferential direction. With the side protector 18, the thickness of the sidewall 11 is increased, so that resistance to external damage is improved.

The surface of the side protector 18 is preferably planar. With the surface of the side protector 18 being planar, airflow around the tire becomes favorable, and air resistance can be reduced. Although a surface of a side protector typically has formed thereon a side rib having a protruding shape that combines straight and curved lines, a recess having a depressed shape, and the like, by forming the surface of the side protector 18 to be planar without patterns or characters, the above-noted advantageous effects can be obtained.

The tread 10 comprises a center land part 20 and shoulder land parts 22. First circumferential grooves 25 extending in the tire circumferential direction are formed between the center land part 20 and the shoulder land parts 22, and a second circumferential groove 27 extending in the tire circumferential direction is formed at approximately the center, in the tire width direction, of the center land part 20. The center land part 20 is divided in the tire width direction by the second circumferential groove 27, and the left and right tread parts partitioned by a plane perpendicular to the tread 10 through the second circumferential groove 27 have shapes identical to each other. In the example shown in FIG. 1, the second circumferential groove 27 and the two first circumferential grooves 25 have depths approximately identical to each other. Here, the depths of the first circumferential grooves 25 and the second circumferential groove 27 each denote a distance in the tire radial direction from the top face of the tread 10 to the groove bottom. The depths of the first circumferential grooves 25 and the second circumferential groove 27 may be approximately constant over the entire length in the tire circumferential direction.

In the example shown in FIG. 1, the center land part 20 is divided into center blocks 36 by the second circumferential groove 27 and by first widthwise grooves 31 arranged sequentially in the tire circumferential direction. Further, the shoulder land parts 22 are divided into shoulder blocks 38 by second widthwise grooves 33 arranged sequentially in the tire circumferential direction in an alternating manner.

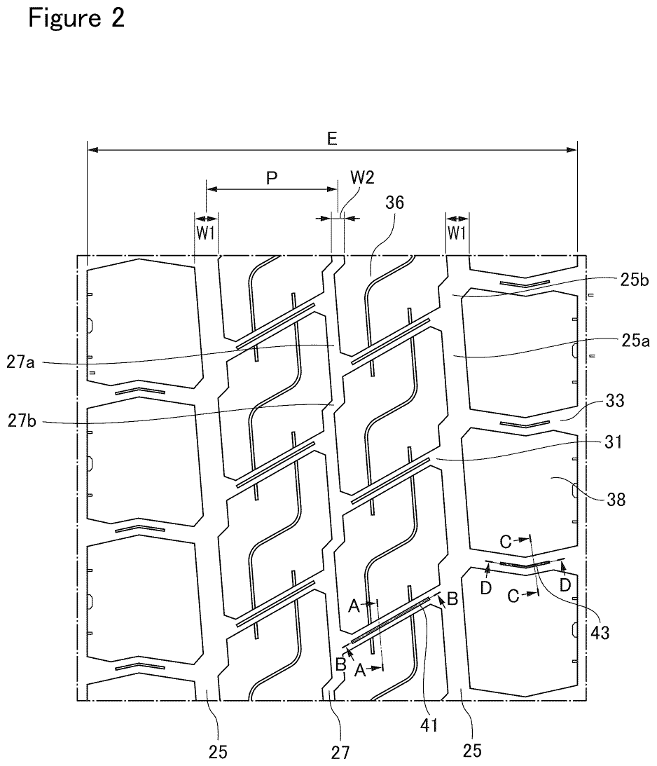

Next, by reference to FIGS. 2 to 9, a more detailed description will be given regarding the tread 10, and in particular regarding the center land part 20. FIG. 2 is an enlarged view of a part of the tread 10 of the heavy load tire 1 according to an example embodiment.

The width W1 of the first circumferential grooves 25 is preferably greater than or equal to 2.5% and less than or equal to 7% of the width E between ground contact edges of the tread 10, and the width W2 of the second circumferential groove 27 is preferably greater than or equal to 2% and less than or equal to 5% of the width between the ground contact edges of the tread 10. Further, the distance P between each of the first circumferential grooves 25 and the second circumferential groove 27 is preferably greater than or equal to 20% and less than or equal to 28% of the width between the ground contact edges of the tread 10. With these features, the center blocks 36 can be made large size and improved in stiffness, and excessive movement of the center blocks 36 during ground contact can be suppressed. The number of pitches of the center blocks 36 and that of the shoulder blocks 38 in the tire circumferential direction are not particularly limited, and both are, for example, less than or equal to 50. By decreasing the number of pitches, the center blocks 36 and the shoulder blocks 38 can be increased in size.

In the present specification, ground contact edges denote two edges, in the tire axial direction, of an area that comes into contact with a flat road surface when an unused heavy load tire 1 is mounted on a normal rim, filled with air to the normal internal pressure, and while in that state, subjected to a load corresponding to 88% of the normal load (or maximum load capacity) for the normal internal pressure.

Here, a “normal rim” is a rim designated by tire standards, and is a “standard rim” according to JATMA, a “design rim” according to TRA, and a “measuring rim” according to ETRTO. The “normal internal pressure” is the “maximum air pressure” according to JATMA, the maximum value shown in the table “TIRE LOAD LIMITS AT VARIOUS COLD INFLATION PRESSURES” according to TRA, and the “inflation pressure” according to ETRTO. The “normal load” is the “maximum load capacity” according to JATMA, the maximum value shown in the table “TIRE LOAD LIMITS AT VARIOUS COLD INFLATION PRESSURES” according to TRA, and the “load capacity” according to ETRTO.

The width W2 of the second circumferential groove 27 is preferably less than the width W1 of the first circumferential grooves 25. With this feature, the center blocks 36 can be made large size and improved in stiffness, and excessive movement of the center blocks 36 during ground contact can be suppressed.

The first circumferential grooves 25 may extend in the tire circumferential direction in a zigzag shape, and the second circumferential groove 27 may likewise extend in the tire circumferential direction in a zigzag shape. In the example shown in FIG. 2, each of the first circumferential grooves 25 is formed by alternately connecting a first slanted portion 25a which is slanted at an angle of greater than or equal to 3° and less than or equal to 10° to the tire circumferential direction, and a second slanted portion 25b slanted at an angle of greater than or equal to 30° and less than or equal to 60° to the tire circumferential direction. The first slanted portion 25a is longer than the second slanted portion 25b. The second circumferential groove 27 is formed by alternately connecting a third slanted portion 27a which is slanted at an angle of greater than or equal to 3° and less than or equal to 10° to the tire circumferential direction, and a fourth slanted portion 27b which is slanted at an angle of greater than or equal to 30° and less than or equal to 60° to the tire circumferential direction. The third slanted portion 27a is longer than the fourth slanted portion 27b.

The first widthwise grooves 31 are slanted at a constant angle to the tire width direction. The angle of the first widthwise grooves 31 to the tire equator is, for example, within a range of greater than or equal to 55° and less than or equal to 85°. At the bottom face of each first widthwise groove 31, a first groove bottom sipe 41 is formed, which is approximately parallel to the first widthwise groove 31. With this feature, sufficient traction performance can be achieved while ensuring stiffness of the center blocks 36. By using the first groove bottom sipes 41, center blocks 36 that are adjacent to each other in the tire circumferential direction are configured to come approximately into contact with each other at the ground contact surface, so that the center land part 20, despite having a block pattern, can have stiffness approximately equivalent to a rib pattern. Here, a sipe is a groove having a thin line shape, with a width narrower than those of the circumferential grooves and the widthwise grooves. In the present specification, a sipe is defined as a groove with a groove width of less than 1.5 mm.

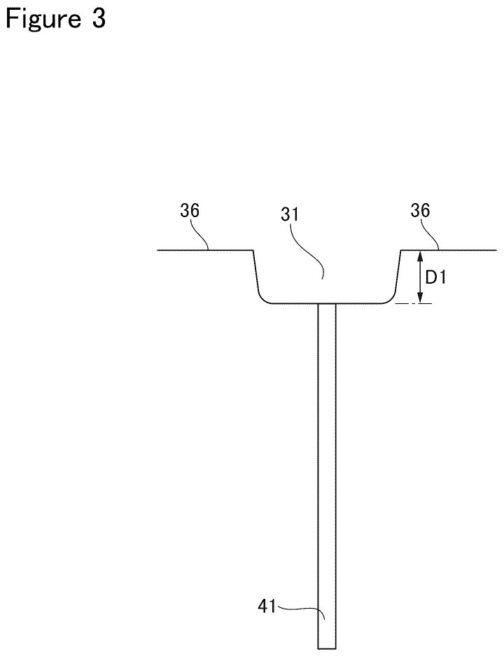

FIG. 3 is a cross-sectional view taken along line A-A in FIG. 2, and shows a cross section of a first widthwise groove 31 and a first groove bottom sipe 41. The first widthwise groove 31 and the first groove bottom sipe 41 may have an approximately rectangular cross section. The first groove bottom sipe 41 is, for example, formed at approximately the center, in the width direction, of the bottom face of the first widthwise groove 31.

The depth D1 of the first widthwise groove 31 is greater than or equal to 10% and less than or equal to 30% of the depth of the first circumferential grooves 25. If D1 is less than 10% of the depth of the first circumferential grooves 25, traction performance would deteriorate, and if D1 exceeds 30% of the depth of the first circumferential grooves 25, the stiffness of the center blocks 36 would decrease. Here, the depth D1 of the first widthwise groove 31 denotes the distance in the tire radial direction from the top face of the center blocks 36 to the groove bottom face. The depth D1 of the first widthwise groove 31 is, for example, approximately constant from an end connected to a first circumferential groove 25 to an end connected to the second circumferential groove 27.

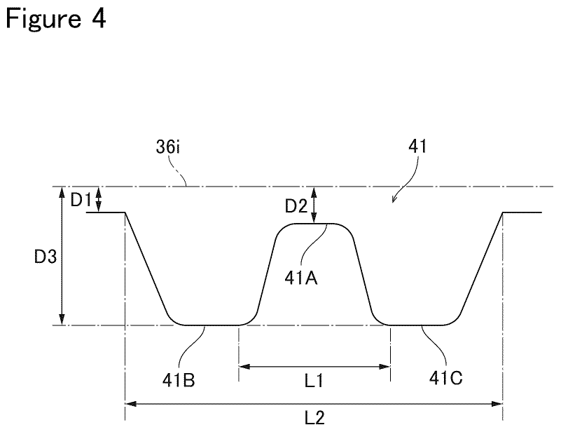

FIG. 4 is a cross-sectional view taken along line B-B in FIG. 2, and shows aspects of the bottom face of the first groove bottom sipe 41. In order to show the depth of the first groove bottom sipe 41, an imaginary line 36i indicating the surface of the center blocks 36 is depicted in FIG. 4. A central portion 41A of the first groove bottom sipe 41 is shallower than an inward portion 41B located inwardly adjacent to the central portion 41A in the tire width direction, and is also shallower than an outward portion 41C located outwardly adjacent to the central portion 41A in the tire width direction. The depth D2 of the central portion 41A is, for example, greater than or equal to 20% and less than or equal to 40% of the depth of the first circumferential grooves 25. Further, the depth D3 of the inward portion 41B and the outward portion 41C is, for example, greater than or equal to 80% and less than or equal to 100% of the depth of the first circumferential grooves 25. With these features, simultaneous achievement of sufficient stiffness of the center blocks 36 and sufficient traction performance becomes more notable. As shown in FIG. 4, the central portion 41A may have a planar bottom face at the depth D2, and the inward portion 41B and the outward portion 41C may have a planar bottom face at the depth D3. The length L1 of the central portion 41A is, for example, greater than or equal to 25% and less than or equal to 75% of the total length L2 of the first groove bottom sipe 41. An inward part of the inward portion 41B in the tire width direction, as well as an outward part of the outward portion 41C in the tire width direction, are connected to the first widthwise groove 31 having the depth D1.

As shown in FIG. 2, the second widthwise grooves 33 may each include a bend. Further, at the groove bottom of each second widthwise groove 33, a second groove bottom sipe 43 approximately parallel to the second widthwise groove 33 may be formed. With this feature, sufficient traction performance can be achieved while ensuring stiffness of the shoulder blocks 38. The second groove bottom sipe 43 may be formed approximately parallel to the second widthwise groove 33, and may be bent in a manner similar to the second widthwise groove 33. Further, as will be described later, the bent portion may be shallower than other portions. By using the second groove bottom sipes 43, shoulder blocks 38 that are adjacent to each other in the tire circumferential direction are configured to come approximately into contact with each other at the ground contact surface, so that each shoulder land part 22, despite having a block pattern, can have stiffness approximately equivalent to a rib pattern.

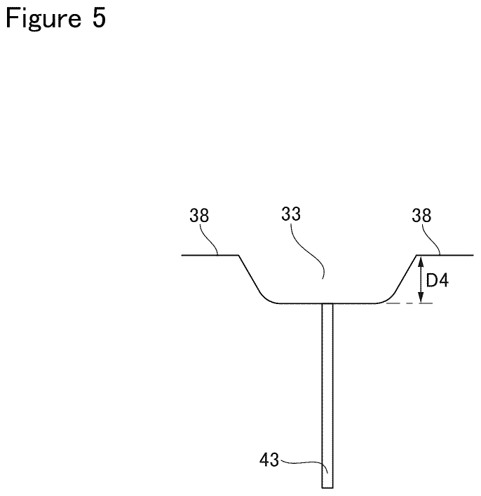

FIG. 5 is a cross-sectional view taken along line C-C in FIG. 2, and shows a cross section of a second widthwise groove 33 and a second groove bottom sipe 43. The second widthwise groove 33 and the second groove bottom sipe 43 may have an approximately rectangular cross section. The second groove bottom sipe 43 is, for example, formed at approximately the center, in the width direction, of the bottom face of the second widthwise groove 33.

The depth D4 of the second widthwise groove 33 is greater than or equal to 10% and less than or equal to 30% of the depth of the first circumferential grooves 25. If D4 is less than 10% of the depth of the first circumferential grooves 25, traction performance would deteriorate, and if D4 exceeds 30% of the depth of the first circumferential grooves 25, the stiffness of the shoulder blocks 38 would decrease. Here, the depth D4 of the second widthwise groove 33 denotes the distance in the tire radial direction from the top face of the shoulder blocks 38 to the groove bottom face. The depth of the second widthwise groove 33 is, for example, approximately constant from an end connected to a first circumferential groove 25 to a ground contact edge.

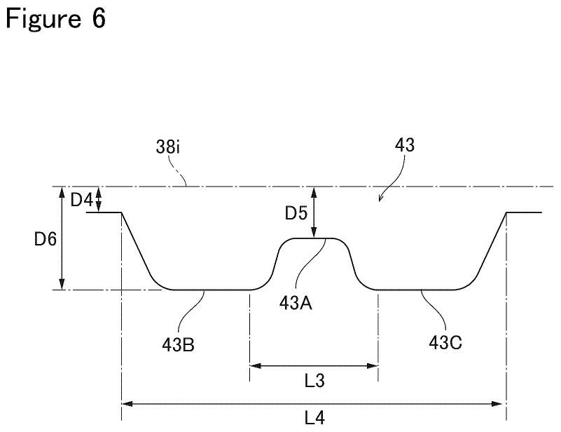

FIG. 6 is a cross-sectional view taken along line D-D in FIG. 2, and shows aspects of the bottom face of the second groove bottom sipe 43. In order to show the depth of the second groove bottom sipe 43, an imaginary line 38i indicating the surface of the shoulder block 38 is depicted in FIG. 6. A central portion 43A of the second groove bottom sipe 43 is shallower than an inward portion 43B located inwardly adjacent to the central portion 43A in the tire width direction, and is also shallower than an outward portion 43C located outwardly adjacent to the central portion 43A in the tire width direction. The depth D5 of the central portion 43A is, for example, greater than or equal to 20% and less than or equal to 40% of the depth of the first circumferential grooves 25. Further, the depth D6 of the inward portion 43B and the outward portion 43C is, for example, greater than or equal to 50% and less than or equal to 70% of the depth of the first circumferential grooves 25. With these features, simultaneous achievement of sufficient stiffness of the shoulder blocks 38 and sufficient traction performance becomes more notable. As shown in FIG. 6, the central portion 43A may have a planar bottom face at the depth D5, and the inward portion 43B and the outward portion 43C may have a planar bottom face at the depth D6. The length L3 of the central portion 43A is, for example, greater than or equal to 25% and less than or equal to 75% of the total length of the second groove bottom sipe 43. An inward part of the inward portion 43B in the tire width direction, as well as an outward part of the outward portion 43C in the tire width direction, are connected to the second widthwise groove 33 having the depth D4.

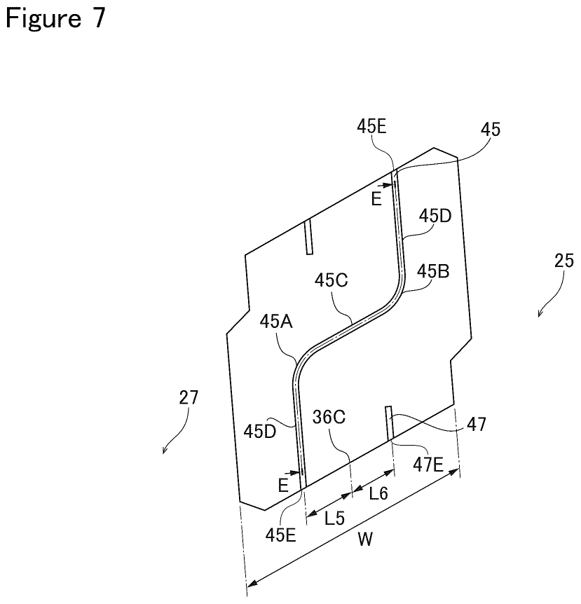

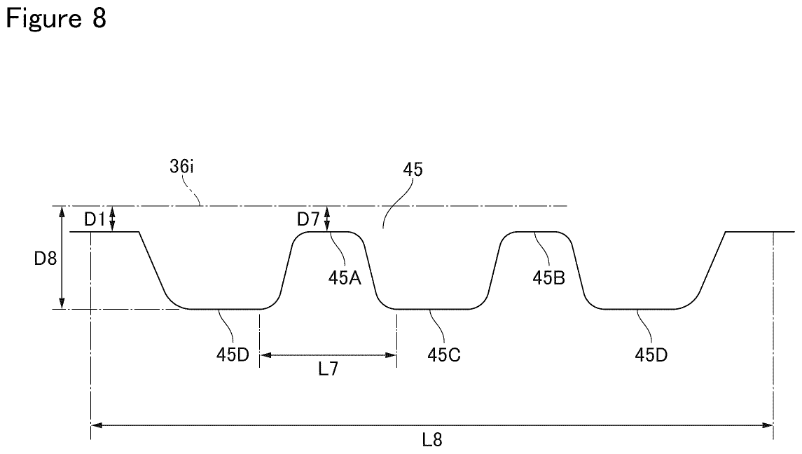

Next, a center block 36 will be described in detail by reference to FIGS. 7 and 8. FIG. 7 is an enlarged view of a center block 36 of the heavy load tire 1 according to an example embodiment. In FIG. 7, a first circumferential groove 25 is located to the right of the center block 36, and the second circumferential groove 27 is located to the left of the center block 36. The center block 36 has an approximately parallelogram shape, with a pair of opposite vertices significantly cut out. With this feature, occurrence of uneven wear at acute-angled parts of the center block 36 can be avoided. The cutout portions at the vertices of the center block 36 may have a size of greater than or equal to 7% and less than or equal to 15% of the center block width, or a size of greater than or equal to 7% and less than or equal to 15% of the circumferential length of the center block.

In the center block 36, a bent sipe 45 and a short sipe 47 are formed. The bent sipe 45 extends in the tire circumferential direction, has both ends opening into the first widthwise grooves 31, and includes two bends 45A, 45B. Further, the bent sipe 45 includes a first straight-line portion 45C located between the bend 45A and the bend 45B, and second straight-line portions 45D each located between one of the bends 45A and 45B and one of the open ends 45E. The second straight-line portions 45D extend approximately parallel to the widthwise ends of the center block 36, that is, approximately parallel to at least one of the first circumferential groove 25 and the second circumferential groove 27. The first straight-line portion 45C extends approximately parallel to the first widthwise grooves 31, and extends in an area around the center, in the circumferential direction, of the center block 36. The first straight-line portion 45C and the second straight-line portions 45D intersect at an obtuse angle at the bends, which correspond to the points of intersection. The short sipe 47 extends in the tire circumferential direction, has one end opening into a first widthwise groove 31, and has the other end terminating within the center block 36. By providing the bent sipe 45 within the center block 36, two segments partitioned in the tire width direction by the bent sipe 45 engage with each other and suppress movement of the center block 36, so that slipping during rolling movement or turning is reduced, and uneven wear is thereby suppressed. Further, by providing the short sipe 47 within the center block 36, movement of the center block 36 in the tire width direction is reduced, and uneven wear is thereby suppressed. The length of the short sipe 47 is greater than or equal to 5% and less than or equal to 15% of the circumferential length of the center block 36. From the perspective of balancing stiffness within the center block 36, the bends 45A, 45B are preferably located at approximately the center, in the tire circumferential direction, of the center block 36.

In the example shown in FIG. 7, the distance L5 between the open end 45E and the center 36C, as well as the distance L6 between the open end 47E and the center 36C, are both greater than or equal to 15% and less than or equal to 20% of the width W of the center block 36. In other words, the open end 45E of the bent sipe 45 and the open end 47E of the short sipe 47 are, for example, located within a range of greater than or equal to 15% and less than or equal to 20% of the width of the center block 36 from the center 36C, in the tire width direction, of the center block 36. With this feature, the balance of stiffness within the center block 36 can be further improved.

FIG. 8 is a cross-sectional view taken along line E-E in FIG. 7, and shows aspects of the bottom face of the bent sipe 45. In order to show the depth of the bent sipe 45, an imaginary line 36i indicating the surface of the center blocks 36 is depicted in FIG. 8. The bends 45A, 45B in the bent sipe 45 are shallower than the first straight-line portion 45C and the second straight-line portions 45D. The depth D7 of the bends 45A, 45B is, for example, greater than or equal to 5% and less than or equal to 30% of the depth of the first circumferential grooves 25. Further, the depth D8 of the first straight-line portion 45C and the second straight-line portions 45D is, for example, greater than or equal to 50 % and less than or equal to 70% of the depth of the first circumferential grooves 25. With these features, simultaneous achievement of sufficient stiffness of the center blocks 36 and sufficient traction performance becomes more notable. As shown in FIG. 8, the bends 45A, 45B may have a planar bottom face at the depth D7, and the first straight-line portion 45C and the second straight-line portions 45D may have a planar bottom face at the depth D8. The length L7 of the bends 45A, 45B is, for example, greater than or equal to 10% and less than or equal to 30% of the total length L8 of the bent sipe 45. Ends of the second straight-line portions 45D are connected to the first widthwise grooves 31 having the depth D1.

The length of the short sipe 47 is not particularly limited, and is, for example, greater than or equal to 10% and less than or equal to 30% of the depth of the first circumferential grooves 25. With this feature, simultaneous achievement of sufficient stiffness of the center blocks 36 and sufficient traction performance becomes more notable. The short sipe 47 may have a planar bottom face at a constant depth.

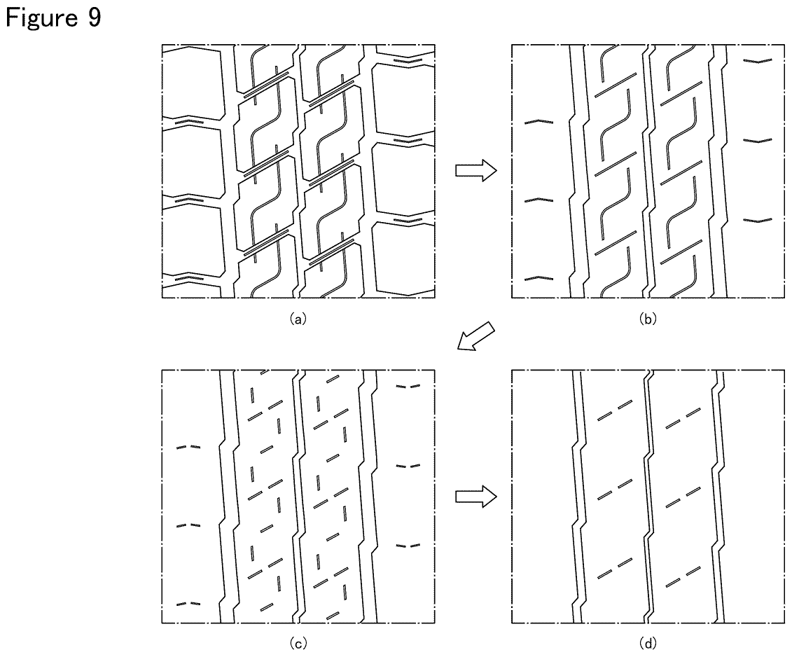

While an unused heavy load tire 1 has been described above using FIGS. 1 to 8, changes in the tread 10 caused by wear will next be described by reference to FIG. 9.

FIG. 9 is a diagram showing changes in the tread 10 caused by wear in the heavy load tire 1 according to an example embodiment. As shown in FIG. 9, when in an unused state illustrated at (a), the center land part has a block pattern divided by widthwise grooves.

The tread wears as a result of using the tire, and in the illustration at (b), the first widthwise grooves and the second widthwise grooves have disappeared, such that the patterns of the center land part and the shoulder land parts have changed from a block pattern to a rib pattern. Further, in the center land part, the short sipes have disappeared. With further use of the tire, the pattern of the tread changes to a pattern shown at (c). While the widthwise grooves are provided in the unused state in order to obtain excellent traction performance, even when, as a result of use, the state of contact between the tire surface and the ground has changed and the widthwise grooves have disappeared, sufficient traction performance can be obtained by means of sipes.

When the first widthwise grooves have disappeared, as shown at (b), the bent sipes may have a shape identical to that in the unused state. As a result of further wear of the tread, as shown at (c), the bends in the bent sipes may disappear, and the bent sipes may thereby be divided into three parts.

When the first widthwise grooves and the second widthwise grooves have disappeared, as shown at (b), the first groove bottom sipes and the second groove bottom sipes may respectively have shapes identical to those in the unused state. As a result of further wear of the tread, as shown at (c), the central portions of the first and second groove bottom sipes may disappear, and each of the groove bottom sipes may thereby be divided into two parts.

As shown at (d), the first groove bottom sipes may remain even after the second groove bottom sipes have disappeared as a result of further wear of the tread. Since the ground contact pressure is higher at the center land part than at the side land parts, by allowing the sipes to remain in the center land part even after the sipes have disappeared in the side land parts, tire traction performance can be ensured. Further progression of wear causes the tread to change to a form in which all sipes have disappeared. When in such a state, a tread wear indicator appears at the tire surface, indicating that it is time to replace the tire.

In an unused state, the width of the second circumferential groove may be narrower than the width of the first circumferential grooves, and the width of the first circumferential grooves may be decreased by wear. Such change in the tread can be caused by setting the inclination of side walls of the first circumferential grooves with respect to the tire radial direction to be greater than the inclination of side walls of the second circumferential groove with respect to the tire radial direction. In the first circumferential grooves having a width greater than that of the second circumferential groove, by configuring such that the side walls have an increased inclination as described above, it is possible to prevent foreign objects such as stones from being caught in the first circumferential grooves.

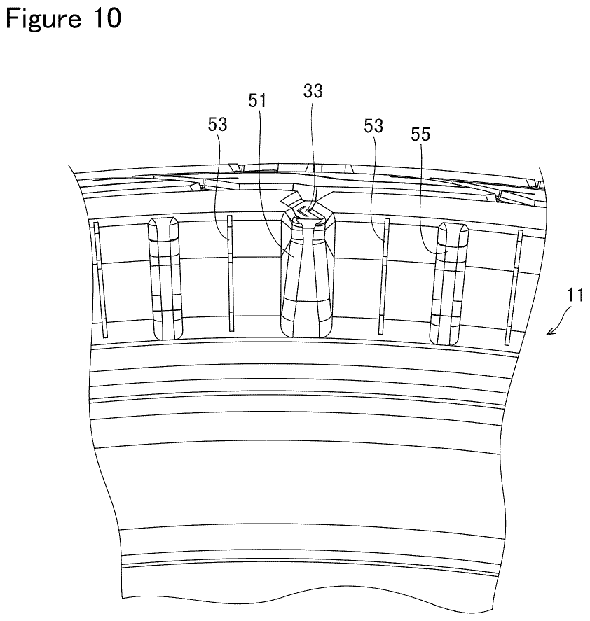

Next, a sidewall 11, and in particular its part around a buttress, will be described by reference to FIG. 10. FIG. 10 is an enlarged view of a part of a sidewall 11 of the heavy load tire 1 according to an example embodiment.

A second widthwise groove 33 may be connected to a lug groove 51 formed in the sidewall 11, and the lug groove 51 may have a depth in the tire radial direction that is greater than that of the first circumferential grooves. In large-sized vehicles such as buses and trucks, the tread is hidden and not visible, and tire wear is typically checked by inspecting the sidewall 11. By forming the lug groove 51 to have an increased depth in the tire radial direction, the degree of tire wear can be recognized more accurately.

Between two lug grooves 51, a side sipe 53 may be formed. Further, a recessed window-like slot 55 having a width greater than that of the side sipe 53 may also be formed. By providing a side sipe 53 or the recessed window-like slot 55, flexibility is provided in the portion of the shoulder land part 22 around the ground contact edge, so that stability in travelling on a rutted road surface can be improved. In the example shown in FIG. 10, in an area extending from one lug groove 51 to an adjacent lug groove 51, two side sipes 53 and one recessed window-like slot 55 are formed in the order of a side sipe 53, a recessed window-like slot 55, and a side sipe 53.

In the tire radial direction, one end of the side sipe 53 may be in contact with the ground contact edge or may extend beyond the ground contact edge to the tread 10, and the other end of the side sipe 53 may extend to a position deeper than the first circumferential grooves. With these features, a lateral force applied to the shoulder land part 22 can be alleviated, and occurrence of uneven wear can be suppressed. In the example shown in FIG. 10, the one end of the side sipe 53 extends beyond the ground contact edge and reaches the tread 10.

As described above, the heavy load tire according to the present disclosure simultaneously achieves sufficient stiffness of the center land part and sufficient traction performance, and exhibits excellent suppression of uneven wear. These advantageous effects can be obtained specifically by including the bent sipes and short sipes having predetermined shapes in the center land part which, in an unused state, is divided into blocks by relatively shallow widthwise grooves each having a groove bottom sipe.

### REFERENCE SIGNS LIST

1 heavy load tire, 10 tread, 11 sidewall, 12 bead, 12a bead core, 12b bead filler, 13 carcass, 14 belt, 15 inner liner rubber, 20 center land part, 22 shoulder land part, 25 first circumferential groove, 27 second circumferential groove, 31 first widthwise groove, 33 second widthwise groove, 36 center block, 38 shoulder block, 41 first groove bottom sipe, 43 second groove bottom sipe, 45 bent sipe, 47 short sipe, 51 lug groove, 53 side sipe, 55 recessed window-like slot.

1. A heavy load tire, comprising a tread including a center land part and a shoulder land part, wherein
a first circumferential groove extending in a tire circumferential direction is formed between the center land part and the shoulder land part, and a second circumferential groove extending in the tire circumferential direction is formed at approximately a center, in a tire width direction, of the center land part,
the center land part is divided into center blocks by the second circumferential groove and by first widthwise grooves arranged sequentially in the tire circumferential direction, and
the center blocks have formed therein: a bent sipe, which extends in the tire circumferential direction, has both ends opening into the first widthwise grooves, and includes two bends; and a short sipe, which extends in the tire circumferential direction, has one end opening into a first widthwise groove, and has the other end terminating within a center block.

2. The heavy load tire according to claim 1, wherein a depth of the first widthwise grooves is greater than or equal to 10% and less than or equal to 30% of a depth of the first circumferential groove, and a first groove bottom sipe is formed at a groove bottom of the first widthwise grooves.

3. The heavy load tire according to claim 1, wherein open ends of the bent sipe and an open end of the short sipe are located within a range of greater than or equal to 15% and less than or equal to 20% of a width of the center block from a center, in the tire width direction, of the center block.

4. The heavy load tire according to claim 1, wherein, in the bent sipe, a depth at open ends and the bends is greater than or equal to 5% and less than or equal to 30% of a depth of the first circumferential groove, and a depth at portions other than the open ends and the bends is greater than or equal to 50% and less than or equal to 70% of the depth of the first circumferential groove.

5. The heavy load tire according to claim 2, wherein, in the first groove bottom sipe, a depth at a central portion is greater than or equal to 20% and less than or equal to 40% of the depth of the first circumferential groove, and a depth at portions adjacent to the central portion is greater than or equal to 80% and less than or equal to 100% of the depth of the first circumferential groove.

6. The heavy load tire according to claim 1, wherein a width of the second circumferential groove is less than a width of the first circumferential groove.

7. The heavy load tire according to claim 1, wherein
a width of the first circumferential groove is greater than or equal to 2.5% and less than or equal to 7% of a width between ground contact edges of the tread, and a width of the second circumferential groove is greater than or equal to 2% and less than or equal to 5% of the width between the ground contact edges of the tread, and
a distance between the first circumferential groove and the second circumferential groove is greater than or equal to 20% and less than or equal to 28% of the width between the ground contact edges of the tread.

8. The heavy load tire according to claim 1, wherein
the shoulder land part is divided into shoulder blocks by second widthwise grooves arranged sequentially in the tire circumferential direction, and
the second widthwise grooves are connected to lug grooves formed in a sidewall, and the lug grooves have a depth in a tire radial direction that is greater than that of the first circumferential groove.

9. The heavy load tire according to claim 8, wherein
a side sipe is formed between the lug grooves, and
in the tire radial direction, one end of the side sipe is in contact with a ground contact edge or extends beyond the ground contact edge to the tread, and the other end of the side sipe extends to a position deeper than the first circumferential groove.

10. The heavy load tire according to claim 1, wherein a side protector protruding outward of the tire from a profile face is formed on a sidewall, and a surface of the side protector is planar.

11. The heavy load tire according to claim 8, wherein a second groove bottom sipe approximately parallel to the second widthwise grooves is formed at a groove bottom of the second widthwise grooves.
